(19) United States
(12) Patent Application Publication
(10) Pub. No.: US 2026/0237353 A1
(43) Pub. Date: Aug. 13, 2026

(54) DISPLAY PANEL AND DRIVING METHOD THEREFOR, AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventor: Xu LU, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 19/122,272

(22) PCT Filed: Jan. 2, 2024
(86) PCT No.: PCT/CN2024/070054

§ 371 Date: Apr. 18, 2025

(30) Foreign Application Priority Data
Jan. 5, 2023 (CN) 202310015085.X

(51) Int. Cl. G09G 3/3266

(52) U.S. Cl. CPC G09G 3/3266; G09G 2300/0408; G09G 2300/0819; G09G 2300/0852; G09G 2310/0245; G09G 2310/0286; G09G 2330/021

(57) ABSTRACT

The present disclosure provides a display panel. The display panel includes a first gate driving circuit, a second gate driving circuit, and a control circuit, the first gate driving circuit includes a plurality of cascaded first shift register units, the second gate driving circuit includes a plurality of cascaded second shift register units, the control circuit includes a plurality of control units, and the first shift register units, the second shift register units and the control units are correspondingly arranged; the control units are connected to output terminals of the first shift register units and input terminals of the second shift register units, and are connected to a restart control terminal, and the control units transmit output signals of the first shift register units to the input terminals of the second shift register units in response to a signal from the restart control terminal.

### CROSS-REFERENCE TO RELATED APPLICATIONS

The present disclosure is the U.S. national phase application of International Application No. PCT/CN2024/070054, filed on Jan. 2, 2024, which claims priority to Chinese Patent Application No. 202310015085.X, filed on Jan. 5, 2023 and entitled “DISPLAY PANEL AND DRIVING METHOD THEREFOR, AND DISPLAY DEVICE”, the entire contents of each are incorporated herein by reference.

### TECHNICAL FIELD

The present disclosure relates to the field of display technology, in particular, to a display panel, a display panel driving method, and a display device.

### BACKGROUND

The OLED display panel refreshes based on frames. Due to the stage-by-stage transmission of a gate driver on Array (GOA), the entire display area can only use the same refresh frequency, which increases the ineffective power consumption of the panel.

### SUMMARY

The purpose of the present disclosure is to overcome the disadvantage of the prior art mentioned above, and provide a display panel, a display panel driving method, and a display device.

According to one aspect of the present disclosure, a display panel is provided. The display panel includes: a first gate driving circuit, a second gate driving circuit, and a control circuit, wherein the first gate driving circuit includes multiple cascaded first shift register units, the second gate driving circuit includes multiple cascaded second shift register units, the control circuit includes multiple control units, and the first shift register units, the second shift register units, and the control units are arranged in correspondence; and wherein the control unit is connected to an output terminal of the first shift register unit, an input terminal of the second shift register unit, and a restart control terminal, and the control unit is configured to transmit, in response to a signal from the restart control terminal, an output signal of the first shift register unit to the input terminal of the second shift register unit.

In some embodiments of the present disclosure, each of the control units share the same restart control terminal.

In some embodiments of the present disclosure, the control unit includes: a first control transistor, wherein a first electrode of the first control transistor is connected to the output terminal of the first shift register unit, a second electrode of the first control transistor is connected to the input terminal of the second shift register unit, a gate of the first control transistor is connected to the restart control terminal, and the first control transistor is configured to transmit, in response to the signal from the restart control terminal, the output signal of the first shift register unit to the input terminal of the second shift register unit.

In some embodiments of the present disclosure, the control unit further includes: a second control transistor, wherein a first electrode and a gate of the second control transistor are connected to the output terminal of the first shift register unit, a second electrode of the second control transistor is connected to the first electrode of the first control transistor, and the second control transistor is configured to transmit, in response to the output signal of the first shift register unit, the output signal to the first electrode of the first control transistor.

In some embodiments of the present disclosure, a duration during which the restart control terminal outputs a turned-on level is 1H.

In some embodiments of the present disclosure, the display panel further includes a pixel driving circuit located in a display area, and the pixel driving circuit includes: a driving transistor, wherein a first electrode of the driving transistor is connected to a second node, a second electrode of the driving transistor is connected to a third node, a gate of the driving transistor is connected to s first node, and the driving transistor is configured to provide a driving current by using a voltage difference between the second node and the third node under control of a voltage at the first node; a first transistor, wherein a first electrode of the first transistor is connected to the first node, a second electrode of the first transistor is connected to a first initial signal terminal, a gate of the first transistor is connected to a first reset signal terminal, and the first transistor is configured to reset, in response to a signal from the first reset signal terminal, the first node using a voltage signal from the first initial signal terminal; and a second transistor, wherein a first electrode of the second transistor is connected to the first node, a second electrode of the second transistor is connected to the third node, a gate of the second transistor is connected to an output terminal of the second shift register unit corresponding thereto, and the second transistor is configured to charge, in response to a gate driving signal output by the second shift register unit, the first node using a voltage signal at the third node; wherein the first reset signal terminal reuses an output signal of the second shift register unit.

In some embodiments of the present disclosure, the first shift register unit and the second shift register unit have the same circuit structures.

In some embodiments of the present disclosure, the first shift register unit and the second shift register unit each includes: an input module connected to an output terminal of a corresponding shift register unit in a previous stage, a fifth node, and a first clock signal terminal, wherein the input module is configured to transmit, in response to a signal from the first clock signal terminal, a received output signal of the previous-stage shift register unit to the fifth node; a pull-down module connected to a fourth node and the first clock signal terminal, wherein the pull-down module receives a first level signal, and is configured to pull, in response to the signal from the first clock signal terminal, down the fourth node using the first level signal; a pull-up module connected the fourth node, the fifth node, and the first clock signal terminal, wherein the pull-up module is configured to pull, in response to a signal at the fifth node, up the fourth node using the signal from the first clock signal terminal; a reset module connected to the fourth node, the fifth node, and a second clock signal terminal, wherein the reset module receives a second level signal, and is configured to reset, in response to a signal at the fourth node and a signal from the second clock signal terminal, the fifth node using the second level signal; a protection module connected to the fifth node and the third node, wherein the protection module receives the first level signal, and is configured to transmit, in response to the first level signal, the signal at the fifth node to the third node, and to be turned off in response to a voltage difference between the first level signal and the signal at the third node; a first output module connected to the fourth node and the output terminal, wherein the first output module receives the second level signal, and is configured to transmit, in response to the signal at the fourth node, the second level signal to the output terminal; a second output module connected to the third node, the output terminal, and the second clock signal terminal, wherein the second output module is configured to transmit, in response to the signal at the third node, the signal from the second clock signal terminal to the output terminal; a second storage module connected to the third node and the output terminal, wherein the second storage module is configured to perform bootstrap on a potential of the third node when a polarity of the signal from the second clock signal terminal is the same as a polarity of the signal at the third node; and a first storage module connected to the fourth node, wherein the first storage module receives the second level signal, and is configured to maintain voltage stability of the fourth node.

In some embodiments of the present disclosure, the second shift register unit includes an input module and an output module, the input module is connected to a first clock signal terminal, and the output module is connected to a second clock signal terminal; when the display panel is driven for display at a same refresh frequency, the first clock signal terminal and the second clock signal terminal alternately output a turned-on level; and when the display panel is driven by different refresh frequencies based on partition regions, both the first clock signal terminal and the second clock signal terminal output a non-turned-on level, and a duration of the non-turned-on level is greater than or equal to 2H.

In some embodiments of the present disclosure, when the display panel is driven for display at a same refresh frequency, a turned-on level output from the first clock signal terminal does not overlap with a turned-on level output from the second clock signal terminal.

In some embodiments of the present disclosure, the input module includes: an eleventh transistor, wherein a first terminal of the eleventh transistor is connected to the output terminal of the corresponding shift register unit in the previous stage, a second terminal of the eleventh transistor is connected to the fifth node, a control terminal of the eleventh transistor is connected to the first clock signal terminal, and the eleventh transistor is configured to transmit, in response to the signal from the first clock signal terminal, the received output signal of the previous-stage shift register unit to the fifth node; the pull-down module includes: a thirteenth transistor, wherein a first terminal of the thirteenth transistor receives the first level signal, a second terminal of the thirteenth transistor is connected to the fourth node, a control terminal of the thirteenth transistor is connected to the first clock signal terminal, and the thirteenth transistor is configured to pull, in response to the signal from the first clock signal terminal, down the fourth node using the first level signal; the pull-up module includes: a twelfth transistor, wherein a first terminal of the twelfth transistor is connected to the fourth node, a second terminal of the twelfth transistor is connected to the first clock signal terminal, a control terminal of the twelfth transistor is connected to the fifth node, and the twelfth transistor is configured to pull, in response to the signal at the fifth node, up the fourth node using the signal from the first clock signal terminal; the reset module includes: a sixteenth transistor, wherein a first terminal of the sixteenth transistor receives the second level signal, a second terminal of the sixteenth transistor is connected to the second node, a control terminal of the sixteenth transistor is connected to the fourth node, and the sixteenth transistor is configured to transmit, in response to the signal at the fourth node, the second level signal to the second node; and a seventeenth transistor, wherein a first terminal of the seventeenth transistor is connected to the second node, a second terminal of the seventeenth transistor is connected to the fifth node, a control terminal of the seventeenth transistor is connected to the second clock signal terminal, and the seventeenth transistor is configured to reset, in response to the signal from the second clock signal terminal, the fifth node using the signal at the second node; the protection module includes: an eighteen transistor, wherein a first terminal of the eighteen transistor is connected to the fifth node, a second terminal of the eighteen transistor is connected to the third node, a control terminal of the eighteen transistor receives the first level signal, and the eighteen transistor is configured to transmit, in response to the first level signal, the signal at the fifth node to the third node, and to be turned off in response to the voltage difference between the first level signal and the signal at the third node; the first output module includes: a fourteenth transistor, wherein a first terminal of the fourteenth transistor receives the second level signal, a second terminal of the fourteenth transistor is connected to the output terminal, a control terminal of the fourteenth transistor is connected to the fifth node, and the fourteenth transistor is configured to transmit, in response to the signal at the fourth node, the second level signal to the output terminal; the second output module includes: a fifteenth transistor, wherein a first terminal of the fifteenth transistor is connected to the second clock signal terminal, a second terminal of the fifteenth transistor is connected to the output terminal, a control terminal of the fifteenth transistor is connected to the third node, and the fifteenth transistor is configured to transmit, in response to the signal at the third node, the signal from the second clock signal terminal to the output terminal for output; the second storage module includes: a second capacitor, wherein one end of the second capacitor is connected to the third node and the other end of the second capacitor is connected to the output terminal, and the second capacitor is configured to perform the bootstrap on the signal at the third node when the polarity of the signal from the second clock signal is the same as the polarity of the signal at the third node; and the first storage module includes: a first capacitor, wherein one end of the first capacitor is connected to the fourth node and the other end of the first capacitor receives the second level signal, and the first capacitor is configured to maintain a potential of the fourth node.

In some embodiments of the present disclosure, the first transistor to the eighth transistor are all P-type transistors.

According to a second aspect of the present disclosure, a display panel driving method for driving the display panel described in any embodiment of the present disclosure is also provided. The method includes: determining a starting row corresponding to a target region on which refreshing needs to be stopped; controlling a target clock signal terminal in a second shift register unit corresponding to the starting row to simultaneously output a non-turned-on level, to control the second shift register unit to continuously output the non-turned-on level; determining a target row on which the refreshing needs to be restarted, wherein a first shift register unit corresponding to the target row outputs a signal having a turned-on level; and controlling a restart control terminal to output a signal having the turned-on level to turn on each control unit, wherein the second shift register unit corresponding to the target row uses the signal having the turned-on level output by the first shift register unit for shift output.

In some embodiments of the present disclosure, a duration during which the target clock signal terminal simultaneously output the non-turned-on level is greater than or equal to 2H.

In some embodiments of the present disclosure, a duration during which the restart control terminal outputs the signal having the turned-on level is 1H.

According to a third aspect of the present disclosure, a display device also provided. The display device includes a display panel as described in any embodiment of the present disclosure.

The display panel provided in the present disclosure includes a first gate driving circuit, a second gate driving circuit, and a control circuit. The first gate driving circuit includes multiple first shift register units, the second gate driving circuit includes multiple second shift register units, and the control circuit includes multiple control units. The first shift register unit, the second shift register unit, and the control unit are arranged in correspondence. When the refresh of a certain row of the display panel needs to be interrupted, the CK/CB signal in the second shift register unit that outputs the gate driving signal to the corresponding row can be simultaneously pulled high. Therefore, the output signal of the previous-stage shift register unit in the second gate driving circuit cannot be output in the present-stage shift register unit, achieving the interruption of the output signal of the second gate driving circuit. When a certain row of the display panel needs to be restarted for the refresh, the restart control terminal can output a turned-on level, thereby transmitting the output signal of the first shift register unit to the input terminal of the second shift register unit. The output signal of the first shift register unit is used to restart the second shift register unit for output, achieving the cascaded output of each second shift register unit in the second gate driving circuit. In this way, the display panel provided in the present disclosure can be finely refreshed based on a partition region and a partition frequency, reducing the ineffective power consumption of the panel.

It should be understood that the general description in the above and the detailed description in the following are only illustrative and explanatory, and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure. It is apparent that the drawings in the following description are only some embodiments of the present disclosure, and for those of ordinary skill in the art, other drawings can also be obtained from these drawings without creative efforts.

FIG. 1 is a schematic diagram of a cascaded gate driving circuit according to one or more embodiments of the present disclosure;

FIG. 2 is a schematic diagram of a cascaded gate driving circuit according to one or more embodiments of the present disclosure;

FIG. 3 is a schematic diagram of a cascaded gate driving circuit according to one or more embodiments of the present disclosure;

FIG. 4 is a schematic diagram of a structure of a pixel driving circuit according to one or more embodiments of the present disclosure;

FIG. 5 is a schematic diagram of a structure of a gate driving circuit of a display panel according to one or more embodiments of the present disclosure;

FIG. 6 is a diagram of a circuit structure of a shift register unit according to one or more embodiments of the present disclosure;

FIG. 7 is a diagram of a circuit structure of a shift register unit according to one or more embodiments of the present disclosure;

FIG. 8 is a timing diagram of the circuit shown in FIG. 7;

FIG. 9 is a schematic diagram of cascaded first gate driving circuit and second gate driving circuit composed of the shift register unit shown in FIG. 8; and

FIGS. 10 to 13 are timing diagrams of the circuit shown in FIG. 9.

### DETAILED DESCRIPTION

Example embodiments will now be described more fully with reference to the drawings. Example embodiments, however, can be embodied in a variety of forms and should not be construed as being limited to examples set forth herein. Instead, these embodiments are provided so that the present disclosure will be thorough and complete, and will fully convey concepts of the example embodiments to those skilled in the art. The same reference numerals in the drawings represent the same or similar structures, and thus their detailed descriptions will be omitted. In addition, the drawings are only illustrative and are not necessarily drawn to scale.

Although relative terms such as “up” and “down” are used in this specification to describe the relative relationship between one component and another component of an icon, these terms are only used for convenience in this specification, for example, according to an example direction described in the drawings. It can be understood that if the device of the icon is flipped so that it is upside down, the component described as “up” will become the component described as “down”. When a certain structure is “on” other structures, it may mean that a structure is formed as a whole on the other structures, or a structure is “directly” arranged on the other structures, or a structure is “indirectly” arranged on the other structures through another structure.

Terms “one”, “a”, “the”, “said”, and “at least one” are used to indicate the existence of one or more elements/components/etc. Terms “include” and “has” are used to indicate open inclusion and refer to the existence of additional elements/components/etc. in addition to the listed ones. Terms “first”, “second”, and “third” are only used as reference numerals and are not intended to limit the quantity of objects.

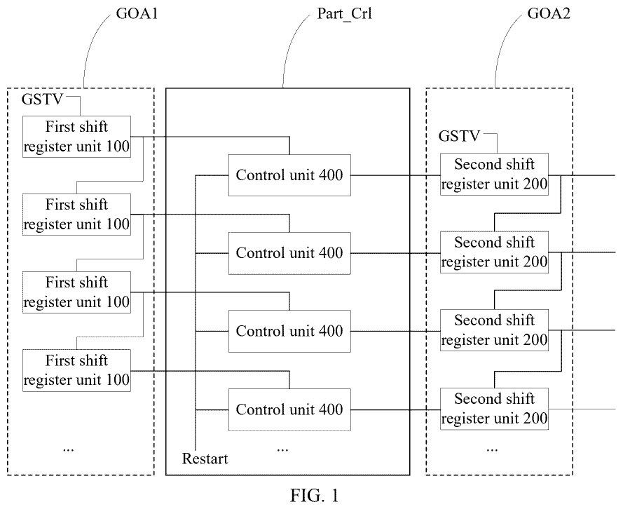

FIG. 1 is a schematic diagram of a cascaded gate driving circuit according to one or more embodiments of the present disclosure. As shown in FIG. 1, the display panel of the present disclosure can include a first gate driving circuit GOA1, a second gate driving circuit GOA2, and a control circuit Part_Crl. The first gate driving circuit GOA1 includes multiple cascaded first shift register units 100, the second gate driving circuit GOA2 includes multiple cascaded second shift register units 200, and the control circuit Part_Crl includes multiple control units 400. The first shift register unit 100, the second shift register unit 200, and the control unit 400 are arranged in correspondence. In some embodiments, the control unit 400 is connected to an output terminal of the first shift register unit 100, an input terminal of the second shift register unit 200, and is also connected to a restart control terminal ‘Restart’. In response to the signal on the restart control terminal ‘Restart’, the control unit 400 transmits an output signal of the first shift register unit 100 to the input terminal of the second shift register unit 200.

The display panel provided in the present disclosure includes a first gate driving circuit GOA1, a second gate driving circuit GOA2, and a control circuit Part_Crl. The first gate driving circuit GOA1 includes multiple first shift register units 100, the second gate driving circuit GOA2 includes multiple second shift register units 200, and the control circuit Part_Crl includes multiple control units 400. The first shift register unit 100, the second shift register unit 200, and the control unit 400 are arranged in correspondence. When the refresh of a certain row of the display panel needs to be interrupted, the CK/CB signal in the second shift register unit 200 that outputs the gate driving signal to the corresponding row can be simultaneously pulled high. Therefore, the output signal of the previous-stage shift register unit in the second gate driving circuit GOA2 cannot be output in the present-stage shift register unit, achieving the interruption of the output signal of the second gate driving circuit GOA2. When a certain row of the display panel needs to be restarted for the refresh, the restart control terminal ‘Restart’ can output a turned-on level, thereby transmitting the output signal of the first shift register unit 100 to the input terminal of the second shift register unit 200. The output signal of the first shift register unit 100 is used to restart the second shift register unit 200 for output, achieving the cascaded output of each second shift register unit 200 in the second gate driving circuit GOA2. In this way, the display panel provided in the present disclosure can be finely refreshed based on a partition region and a partition frequency, reducing the ineffective power consumption of the panel.

The circuit structure of the first shift register unit 100 and the circuit structure of the second shift register unit 200 in the present disclosure are the same or different. In some embodiments, the circuit structure of the first shift register unit 100 and the circuit structure of the second shift register unit 200 in the present disclosure are the same, so that the gate driving signal output by the first shift register unit 100 has the same characteristics as the gate driving signal output by the second shift register unit 200. By using the output signal of the first shift register unit 100 to restart the second shift register unit 200, the gate driving signal output by the second shift register unit 200 can have the same signal characteristics as the gate driving signal that is output based on a cascade signal used by the second gate driving circuit GOA2 itself, ensuring that the output signal of the second shift register unit 200 is not distorted and thus ensuring the display effect of the display panel. It should be understood that the circuit structures of the two shift register units described in the present disclosure are the same.

The first shift register unit 100 and the second shift register unit 200 in the present disclosure both have cascaded multiple stages. That is, the input terminal of the first-stage shift register unit is connected to the initial signal input terminal GSTV, and the output signal of the previous-stage shift register unit is used as the input signal of the next-stage shift register unit, so as to output a shift signal stage by stage. The first shift register unit 100 and the second shift register unit 200 are both used to output the gate driving signal to the pixel driving circuit of the corresponding row in the display area. For convenience of describing uniformly, the shift register unit and the pixel driving circuit in the display area connected to the shift register unit in the present disclosure is described as being in the same row to illustrate the schemes. That is, when describing the refresh interruption of the m^{th} row, it means that the shift register unit in the m^{th} row stops providing the gate driving signal to the pixel driving circuit in the m^{th} row, or when describing the refresh restart of the nth row, it means that the shift register unit in the nth row stops providing the gate driving signal to the pixel driving circuit in the nth row.

It can be understood that the display panel usually includes a display driver integrated circuit (DDIC), and the restart control terminal ‘Restart’ can be output by the display driver integrated circuit DDIC. When it is necessary to control a certain region to stop refreshing, for example, when the refresh needs to be interrupted from the (n+1)^{th} row, the CK and CB signals in the second shift register unit 200 that outputs the gate driving signal to the (n+1)^{th} row can be controlled to be pulled high at the same time, so that the output signal of the second shift register unit 200 in the n^{th} row cannot be output in the second shift register unit 200 in the (n+1)^{th} row. In this way, the output signal of the second gate driving circuit GOA2 can be interrupted from the (n+1)^{th} row, and thus achieving the refresh interruption from the (n+1)^{th} row. The specific principle of the refresh interrupt can be found in the subsequent implementation embodiments, which will not be elaborated here.

It should be noted that the signal on the restart control terminal ‘Restart’ in the present disclosure is a global signal, which means that when the restart control terminal ‘Restart’ outputs a turned-on level, all control units 400 will be turned on. When restarting the refresh from the m^{th} row, the display driver integrated circuit DDIC can control the restart control terminal ‘Restart’ to output the turned-on level when the first shift register unit 100 in the m^{th} row outputs the cascade signal. The control unit 400 is turned on and transmits the output signal of the first shift register unit 100 in the m^{th} row to the second shift register unit 200 in the m^{th} row, so that the second shift register unit 200 in the m^{th} row starts outputting a signal of the turned-on level again, i.e., restarts the refresh, and so that the cascade transmission is restarted. As a result, the refresh of the m^{th} pixel row in the display area is restarted.

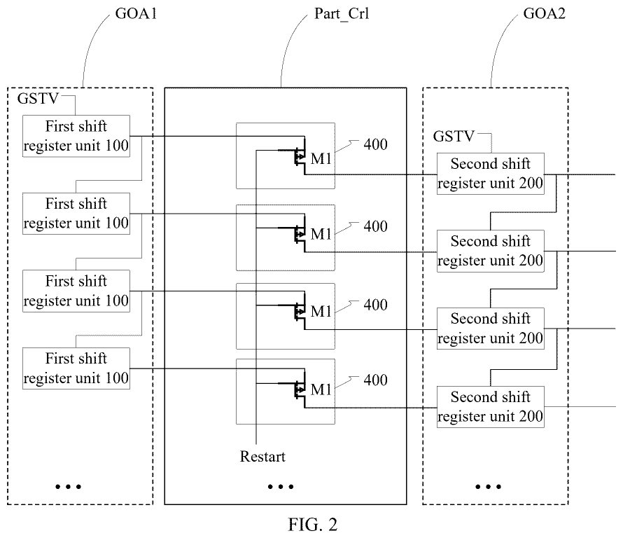

The control unit 400 disclosed in the present disclosure can be implemented through transistors. FIG. 2 is a schematic diagram of a cascaded gate driving circuit according to one or more embodiments of the present disclosure. As shown in FIG. 2, in some embodiments, each control unit 400 can include a first control transistor M1. A first electrode of the first control transistor M1 is connected to the output terminal of the first shift register unit 100, a second electrode of the first control transistor M1 is connected to the input terminal of the second shift register unit 200, and a gate of the first control transistor M1 is connected to the restart control terminal ‘Restart’. The first control transistor M1 can transmit, in response to the signal from the restart control terminal ‘Restart’, the output signal of the first shift register unit 100 to the input terminal of the second shift register unit 200. In some embodiments, the first control transistor M1 can be a P-type transistor. The display driver integrated circuit DDIC can determine a time instant at which the first shift register unit 100 in the m^{th} row outputs the cascade signal. The display driver integrated circuit DDIC further controls the restart control terminal ‘Restart’ to output a low level. Then, the first control transistor M1 is turned on, and the cascade signal output from the first shift register unit 100 in the m^{th} row is transmitted to the second shift register unit 200 in the m^{th} row. In this way, it is equivalent that the second shift register unit 200 in the m^{th} row obtains the cascade signal output from the previous-stage second shift register unit 200 and starts output a cascade signal again, that is, the second shift register unit 200 is restarted using the output signal of the first shift register unit 100. According to embodiments of the present disclosure, by using a transistor to form the control unit 400, the signal attenuation can be reduced and the fidelity of the signal output from the first shift register unit 100 can be improved.

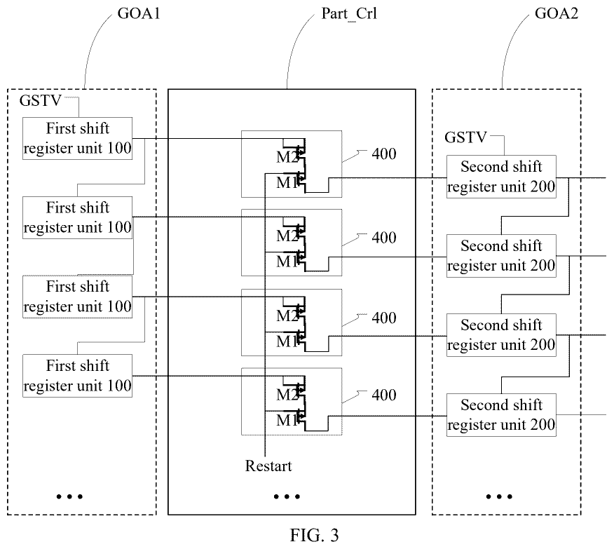

In some other embodiments of the present disclosure, the control unit 400 can also have other circuit structures, for example, the control unit 400 can include two transistors. FIG. 3 is a schematic diagram of a cascaded gate driving circuit according to one or more embodiments of the present disclosure. As shown in FIG. 3, each control unit 400 can include a first control transistor M1 and a second control transistor M2. A first electrode and a gate of the second control transistor M2 are both connected to the output terminal of the first shift register unit 100, a second electrode of the second control transistor M2 is connected to a first electrode of the first control transistor M1, a second electrode of the first control transistor M1 is connected to the input terminal of the second shift register unit 200, and a gate of the first control transistor M1 is connected to the restart control terminal ‘Restart’. In this way, in response to the output signal of the first shift register unit 100, the second control transistor M2 can transmit the output signal to the first terminal of the first control transistor M1. Therefore, the control unit 400 can also be turned on by controlling the restart control terminal ‘Restart’ to output a low-level signal, and the output signal of the first shift register unit 100 in the same row can be used to restart the second shift register unit 200, so that the display panel can start refreshing again from this row. In some embodiments, the first control transistor M1 and the second control transistor M2 have transistors of the same type, for example, the transistors can both be P-type transistors. In some other embodiments, the control unit 400 can also have other circuit structures, which will not be described in detail here. Compared to the embodiment shown in FIG. 2, the embodiment shown in FIG. 3 is more conducive to controlling the restart required in the row. Specifically, there may be noise signals in the signals output from the first shift register unit 100, which cannot be used to turn on the second control transistor M2. Therefore, the circuit structure shown in FIG. 3 will not cause the second shift register unit 200 to be turned on due to the global signal on the restart control terminal ‘Restart’. In other words, the circuit structure shown in FIG. 3 will not erroneously restart the corresponding second shift register unit 200 due to the presence of noise signals in the signals output from the first shift register unit 100, improving the operational reliability of the circuit.

That the output level of a certain terminal described is a turned-on level in the present disclosure can be understood as that the output level of the terminal can turn on or open the circuit structure connected to the terminal. Correspondingly, the output level of a certain terminal is a non-turned-on level, which means that the level of the signal output by the terminal can control the circuit structure connected to this terminal to be turned off.

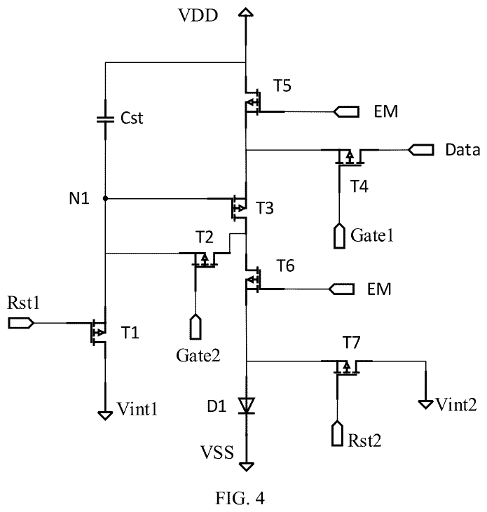

It can be understood that the first gate driving circuit GOA1 is used to output the first gate driving signal, the second gate driving circuit GOA2 is used to output the second gate driving signal, and the first gate driving signal and the second gate driving signal are used to control transistors with different functions in the pixel driving circuit in the display area. FIG. 4 is a schematic diagram of a structure of a pixel driving circuit according to one or more embodiments of the present disclosure. As shown in FIG. 4, the pixel driving circuit of the present disclosure can include a first transistor T1 to a seventh transistor T7. A first electrode of the first transistor T1 is connected to the first node N1, a second electrode of the first transistor T1 is connected to the first initial signal terminal Vinit1, and a gate of the first transistor T1 is connected to the first reset signal terminal Rst1. A first electrode of the second transistor T2 is connected to the first node N1, a second electrode of the second transistor T2 is connected to a second electrode of the driving transistor T3, and a gate of the second transistor T2 is connected to the second gate signal terminal Gate2. A gate of the driving transistor T3 is connected to the first node N1. A first electrode of the fourth transistor T4 is connected to the data signal terminal ‘Data’, a second electrode of the fourth transistor T4 is connected to a first electrode of the driving transistor T3, and a gate of the fourth transistor T4 is connected to the first gate signal terminal Gate1. A first electrode of the fifth transistor T5 is connected to the first power terminal VDD, a second electrode of the fifth transistor T5 is connected to the first electrode of the driving transistor T3, and a gate of the fifth transistor T5 is connected to the enabling signal terminal EM. A first electrode of the sixth transistor T6 is connected to the second electrode of the driving transistor T3, a second electrode of the sixth transistor T6 is connected to the anode of the light-emitting unit OLED, and a gate of the sixth transistor T6 is connected to the enabling signal terminal EM. A first electrode of the seventh transistor T7 is connected to the second initial signal terminal Vinit2, a second electrode of the seventh transistor T7 is connected to the anode of the light-emitting unit OLED, a gate of the seventh transistor T7 is connected to the second reset signal terminal Rst2, and the cathode of the light-emitting unit OLED is connected to the second power terminal VSS. One end of the storage capacitor Cst is connected to the first node N1, and the other end is connected to the first electrode of the fifth transistor T5.

It should be understood that the above FIG. 4 is only an exemplary illustration of the transistors controlled by the first gate driving circuit GOA1 and the second gate driving circuit GOA2. In some other embodiments, the first gate driving circuit GOA1 and the second gate driving circuit GOA2 can also be used to control transistors having other functions in the pixel driving circuit. In some embodiments, the first gate driving circuit GOA1 is used to output a first gate driving signal for controlling the fifth transistor T5 and the sixth transistor T6. The second gate driving circuit GOA2 is used to output a second gate driving signal for controlling the fourth transistor T4 or the second transistor T2. Alternatively, in some embodiments, the second gate driving circuit GOA2 is used to output the first gate driving signal, which is used to control the fifth transistor T5 and the sixth transistor T6, and the first gate driving circuit GOA1 is used to output the second gate driving signal, which is used to control the fourth transistor T4 or the second transistor T2. In this way, the first gate driving circuit GOA1 and the second gate driving circuit GOA2 can be provided to have the same circuit structures shown in FIG. 1, and can also be used to achieve driving based on the partition region and partition frequency, as well as refresh restarting for any pixel row as described in the present disclosure.

The driving method of the pixel driving circuit can include the following processes: in a reset phase, both the first reset signal terminal Rst1 and the second reset signal terminal Rst2 output turned-on levels, thereby controlling the first transistor T1 and the seventh transistor T7 to be turned on. The first transistor T1 resets the first node N1 using the signal from the first initial signal terminal Vinit1, and the seventh transistor T7 resets the anode of the light-emitting unit OLED using the signal from the second initial signal terminal Vinit2. In a charging phase, both the first gate signal terminal Gate1 and the second gate signal terminal Gate2 output the turned-on levels, the second transistor T2 and the fourth transistor T4 are controlled to be turned on. The data signal terminal ‘Data’ outputs a data signal Vdata, and Vdata+Vth (i.e., a sum of voltages Vdata and Vth) is written into the first node N1, where Vth is the threshold voltage of the driving transistor T3. In a light-emitting phase, the enabling signal terminal EM outputs the turned-on level, the driving transistor T3, the fifth transistor T5, and the sixth transistor T6 are turned on. The driving transistor T3 provides a driving current under the the voltage signal Vdata+Vth stored in the storage capacitor Cst, driving the light-emitting unit OLED to emit light.

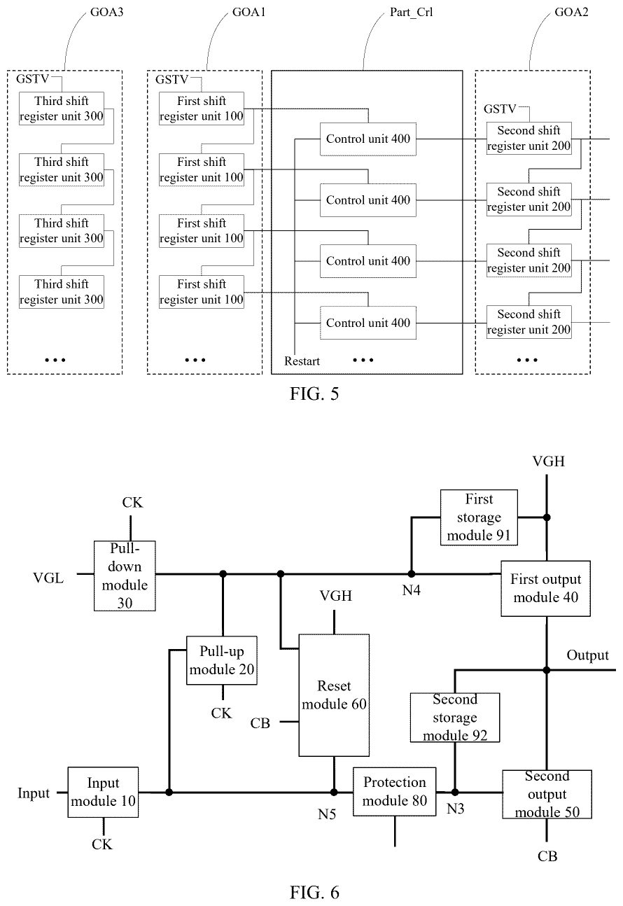

In some embodiments, the second gate signal terminal Gate2 can be connected to the output terminal of the second shift register unit 200, that is, the second shift register unit 200 provides the second gate signal terminal Gate2 with a corresponding gate driving signal. In addition, the output signal of the second shift register unit 200 can be reused by the first reset signal terminal Rst1, that is, the first reset signal terminal Rst1 is provided with the first reset signal by using the output signal of the second shift register unit 200. The first gate signal terminal Gate1 can be connected to the output terminal of the first shift register unit 100, that is, the corresponding gate driving signal is provided to the first gate signal terminal Gate1 through the first shift register unit 100. Moreover, the output signal of the first shift register unit 100 can be reused by the second reset signal terminal Rst2, that is, the second reset signal terminal Rst2 is provided with the second reset signal using the output signal of the first shift register unit 100. In addition, FIG. 5 is a schematic diagram of a structure of a gate driving circuit of a display panel according to one or more embodiments of the present disclosure. As shown in FIG. 5, in some embodiments, the display panel can further include a third gate driving circuit GOA3. Similarly, the third gate driving circuit GOA3 includes multiple cascaded third shift register units 300, and the enabling signal terminal EM can be connected to an output terminal of the third shift register unit 300, that is, the third gate driving circuit GOA3 provides the enabling signal for the enabling signal terminal EM. In this way, the display panel provided by the present disclosure can include three groups of shift register circuits, and the three groups of shift register circuits can be used to control the on/off of transistors with different functions in the pixel driving circuit.

In some embodiments, when the first transistor T1 is turned on, the first node N1 can be reset, and when the second transistor T2 and the fourth transistor T4 are turned on, the data signal from the data signal terminal ‘Data’ can be written to the first node N1. The voltage of the first node N1 determines the amount of the driving current that can be provided. In one frame of data, the first transistor T1 and the second transistor T2 are turned on once respectively. Therefore, by controlling the on/off of the first transistor T1 and the second transistor T2, the accuracy of data refreshing can be improved. As mentioned above, the signal from the first reset signal terminal Rst1 that controls the on/off of the first transistor T1 and the signal from the second gate signal terminal Gate2 that controls the on/off of the second transistor T2 are both provided by the second shift register unit 200. Therefore, by controlling the output interruption of the second shift register unit 200 to stop refreshing a certain region, and by starting the second shift register unit 200 again to output a cascade signal to restart the corresponding region and start refreshing, the accuracy of driving based on the partition region and the partition frequency can be improved.

In some embodiments, the first transistor T1 to the seventh transistor T7 can be all P-type transistors, for example, P-type low-temperature polycrystalline silicon thin film transistors. In some other embodiments, some transistors can also be N-type transistors, such as N-type oxide thin film transistors. For example, the channel regions of the first transistor T1 and the second transistor T2 can be formed of indium gallium zinc oxide. N-type oxide thin film transistors have smaller leakage currents, which can reduce the leakage current during the light-emitting phase. When the first transistor T1 and the second transistor T2 are N-type transistors, an inverter can be configured for the second shift register unit to control the on/off of the first transistor T1 and the second transistor T2.

It should be understood that the pixel driving circuit shown in FIG. 4 is only an exemplary illustration and should not be construed as a limitation on the pixel driving circuit disclosed in the present disclosure. In some other embodiments of the present disclosure, the pixel driving circuit can also have other circuit structures, such as 7T2C, 8T1C, etc., which will not be described in detail here.

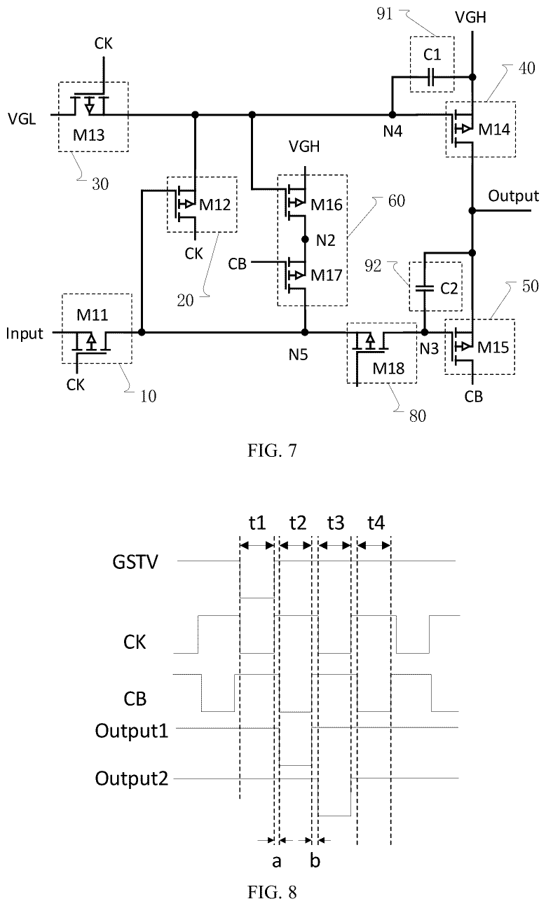

FIG. 6 is a diagram of a circuit structure of a shift register unit according to one or more embodiments of the present disclosure. As shown in FIG. 6, in some embodiments, the circuit structures of the first shift register unit 100 and the second shift register unit 200 are the same, both of which can include an input module 10, a pull-down module 30, a pull-up module 20, a reset module 60, a protection module 80, a first output module 40, a second output module 50, as well as a first storage module 91 and a second storage module 92. The input module 10 is connected to the output terminal ‘Output’ of the corresponding shift register unit in the previous stage, the fifth node N5, and the first clock signal terminal CK. In response to the signal from the first clock signal terminal CK, the input module 10 transmits the output signal received from the previous-stage shift register unit to the fifth node N5. The pull-down module 30 is connected to the fourth node N4 and receives a first level signal VGL and a first clock signal terminal CK. In response to the signal from the first clock signal terminal CK, the pull-down module 30 pulls down the fourth node N4 using the first level signal VGL. The pull-up module 20 is connected to the fourth node N4, the fifth node N5, and the first clock signal terminal CK. In response to the signal from the fifth node N5, the pull-up module 20 pulls up the fourth node N4 using the signal from the first clock signal terminal CK. The reset module 60 is connected to the fourth node N4, the fifth node N5, and the second clock signal terminal CB, and receives the second level signal VGH. In response to the signal from the fourth node N4 and the signal from the second clock signal terminal CB, the reset module 60 resets the fifth node N5 using the second level signal VGH. The protection module 80 is connected to the fifth node N5 and the third node N3, and receives the first level signal VGL. The protection module 80 transmits, in response to the first level signal VGL, the signal on the fifth node N5 to the third node N3, and is turned off in response to the voltage difference between the signal from the third node N3 and the first level signal VGL. The first output module 40 is connected to the fourth node N4 and the output terminal ‘Output’, and receives the second level signal VGH. In response to the signal from the fourth node N4, the first output module 40 transmits the second level signal VGH to the output terminal ‘Output’. The second output module 50 is connected to the third node N3, the output terminal ‘Output’, and the second clock signal terminal CB. In response to the signal from the third node N3, the second output module 50 transmits the signal from the second clock signal terminal CB to the output terminal ‘Output’. The first storage module 91 is connected to the fourth node N4 and receives the second level signal VGH, and the second storage module 92 is connected to the third node N3 and the output terminal ‘Output’.

In some embodiments, the first clock signal terminal CK and the second clock signal terminal CB can alternately output a turned-on level. That is, when the first clock signal terminal CK outputs a turned-on level (such as a low level), the second clock signal terminal CB outputs a non-turned-on level (such as a high level), and when the first clock signal terminal CK outputs a non-turned-on level, the second clock signal terminal CB outputs a turned-on level.

The first level signal VGL and the second level signal VGH are signals of opposite polarity. The first level signal VGL can be a low-level signal, and the second level signal VGH can be a high-level signal.

The input terminal of the input module 10 is connected to the output terminal ‘Output’ of the corresponding shift register unit in the previous stage, and the input terminal of the first-stage shift register unit is connected to the initial signal input terminal GSTV. When the first clock signal terminal CK outputs a turned-on level and the previous-stage shift register unit outputs a turned-on level signal, the input module 10 is turned on and sets the fifth node N5 to be the turned-on level. Then, the first clock signal terminal CK outputs a non-turned-on level and the second clock signal terminal CB outputs a turned-on level. At this time, the input module 10 and the pull-down module 30 are turned off, and the fifth node N5 controls the pull-up module 20 to be turned on, and uses the non-turned-on level of the first clock signal terminal CK to pull up the fourth node N4, thereby turning off the first output module 40. At the same time, the third node N3 maintains the turned-on level and controls the second output module 50 to be turned on. The second output module 50 is turned on and transmits the turned-on level of the second clock signal terminal CB to the output terminal ‘Output’, so that the shift register unit outputs the turned-on level and achieves the shift output of the shift register unit.

When the fourth node N4 is at the turned-on level and the second clock signal terminal CB outputs the turned-on level, the reset module 60 is turned on and transmits the second level signal VGH to the fifth node N5 to reset the fifth node N5.

The first storage module 91 can stabilize the voltage of the fourth node N4, and the second storage module 92 performs a bootstrap when both the third node N3 and the second clock signal terminal CB are at the turned-on level, further pulling down the potential of the third node N3.

Due to the bootstrap effect of the second storage module 92, the potential of the third node N3 will be further pulled down. When the potential of the third node N3 is lower than the potential of the first level signal VGL, the protection module 80 will be turned off, which can prevent the potential of the fifth node N5 from being affected. In other words, the protection module 80 can avoid the influence of the potential of the third node N3 on the potential of the fifth node N5, maintain the stability of the potential of the fifth node N5, and protect the input module 10, the pull-up module 20, and the reset module 60, so that a stable operation state can be maintained.

It should be understood that the term “pull-up” used in the present disclosure refers to the potential at a corresponding circuit node being pulled up to a high level, and the term “pull-down” refers to the potential at a corresponding circuit node being pulled down to a low level. It can be understood that both the “pull-up” and “pull-down” mentioned above can be achieved through directional movement of charges, and therefore can be specifically achieved through electronic devices with corresponding functions or combinations of the electronic devices, which is not limited in the present disclosure.

In addition, when using the circuit structure shown in FIG. 6 to implement the cascade relationship shown in FIG. 1, the output terminal ‘Output’ of the shift register unit in the first gate driving circuit GOA1 can be connected to the input terminal of the control unit 400, the output terminal of the control unit 400 can be connected to the input terminal of the shift register unit in the second gate driving circuit GOA2, and the control terminal of the control unit 400 can be connected to the restart control terminal ‘Restart’, so that under the control by the signal on the restart control terminal ‘Restart’, the shift register units in the first gate driving circuit GOA1 can be cascaded with the shift register units in the second gate driving circuit GOA2 of the same stage, to achieve the circuit function shown in FIG. 1.

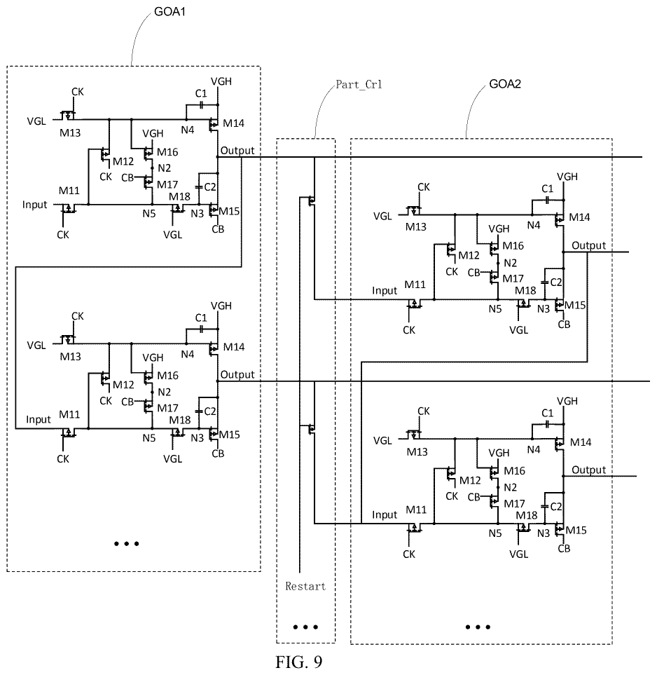

In some embodiments, both the first shift register and the second shift register can be implemented through transistors. For example, FIG. 7 is a diagram of a circuit structure of a shift register unit according to one or more embodiments of the present disclosure. As shown in FIG. 7, the input module 10 can include an eleventh transistor M11. A first terminal of the eleventh transistor M11 is connected to the output terminal ‘Output’ of the corresponding shift register unit in the previous stage, a second terminal of the eleventh transistor M11 is connected to the fifth node N5, and a control terminal of the eleventh transistor M11 is connected to the first clock signal terminal CK. In response to the signal from the first clock signal terminal CK, the eleventh transistor M11 transmits the received output signal of the previous-stage shift register unit to the fifth node N5. The pull-down module 30 can include a thirteenth transistor M13. A first terminal of the thirteenth transistor M13 receives the first level signal VGL, a second terminal of the thirteenth transistor M13 is connected to the fourth node N4, and a control terminal of the thirteenth transistor M13 is connected to the first clock signal terminal CK. In response to the signal from the first clock signal terminal CK, the thirteenth transistor M13 transmits the first level signal VGL to the fourth node N4. The pull-up module 20 can include a twelfth transistor M12. A first terminal of the twelfth transistor M12 is connected to the fourth node N4, a second terminal of the twelfth transistor M12 is connected to the first clock signal terminal CK, and a control terminal of the twelfth transistor M12 is connected to the fifth node N5. In response to the signal from the fifth node N5, the twelfth transistor M12 pulls up the fourth node N4 using the signal from the first clock signal terminal CK. The reset module 60 can include a sixteenth transistor M16 and a seventeenth transistor M17. A first terminal of the sixteenth transistor M16 receives the second level signal VGH, a second terminal of the sixteenth transistor M16 is connected to the second node N2, and a control terminal of the sixteenth transistor M16 is connected to the fourth node N4. In response to the signal from the fourth node N4, the sixteenth transistor M16 transmits the second level signal VGH to the second node N2. A first terminal of the seventeenth transistor M17 is connected to the second node N2, a second terminal of the seventeenth transistor M17 is connected to the fifth node N5, and a control terminal of the seventeenth transistor M17 is connected to the second clock signal terminal CB. In response to the signal from the second clock signal terminal CB, the seventeenth transistor M17 resets the fifth node N5 using the signal from the second node N2. The protection module 80 can include an eighteenth transistor M18. A first terminal of the eighteenth transistor M18 is connected to the fifth node N5, a second terminal of the eighteenth transistor M18 is connected to the third node N3, and a control terminal of the eighteenth transistor M18 receives the first level signal VGL. The eighteenth transistor M18 transmits the signal of the fifth node N5 to the third node N3 in response to the first level signal VGL, or the eighteenth transistor M18 is turned off in response to the voltage difference between the first level signal VGL and the signal at the third node N3. The first output module 40 can include a fourteenth transistor M14. A first terminal of the fourteenth transistor M14 receives a second level signal VGH, a second terminal of the fourteenth transistor M14 is connected to the output terminal ‘Output’, and a control terminal of the fourteenth transistor M14 is connected to the fourth node N4. In response to the signal from the fourth node N4, the fourteenth transistor M14 transmits the second level signal VGH to the output terminal 'Output'. The second output module 50 can include a fifteenth transistor M15. A first terminal of the fifteenth transistor M15 is connected to the second clock signal terminal CB, a second terminal of the fifteenth transistor M15 is connected to the output terminal ‘Output’, and a control terminal of the fifteenth transistor M15 is connected to the third node N3. In response to the signal from the third node N3, the fifteenth transistor M15 transmits the signal from the second clock signal terminal CB to the output terminal ‘Output’. The second storage module 92 can include a second capacitor C2, one end of the second capacitor C2 is connected to the third node N3 and the other end of the second capacitor C2 is connected to the output terminal ‘Output’. The second capacitor C2 is used to perform the bootstrap on the signal of the third node N3 when the polarity of the second clock signal and the signal at the third node N3 are the same. The first storage module 91 can include a first capacitor C1, one end of the first capacitor C1 is connected to the fourth node N4, and the other end of the first capacitor C1 receives the second level signal VGH. The first capacitor C1 can be used to maintain the stable potential of the fourth node N4.

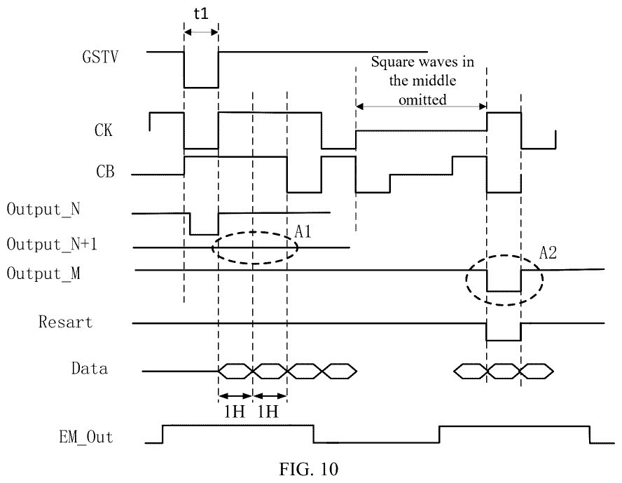

In some embodiments, the eleventh transistor M11 to the eighteenth transistor M18 mentioned above can be all P-type transistors. FIG. 8 is a timing diagram of the circuit shown in FIG. 7. The driving method of the shift register unit can include four phases, where the first level signal VGH is a high-level signal and the second level signal VGL is a low-level signal. The turned-on level output from the first clock signal terminal CK and the second clock signal terminal CB can be at a low level. In some embodiments, when implementing the cascade relationship shown in FIG. 1 using the circuit structure shown in FIG. 7, the output terminal of the shift register unit in the first gate driving circuit GOA1 can be connected to the input terminal of the control unit 400, and the output terminal of the control unit 400 can be connected to the input terminal of the shift register unit in the second gate driving circuit GOA2. The control terminal of the control unit 400 can be connected to the restart control terminal ‘Restart’, so that under the control of the signal on the restart control terminal ‘Restart’, the shift register units in the first gate driving circuit GOA1 can be cascaded with the shift register units in the second gate driving circuit GOA2 of the same stage, to achieve the circuit function shown in FIG. 1. In some other embodiments, the shift register unit can also have other circuit structures, and the shift register unit of other circuit structures can also be used to achieve, based on the concept disclosed in the present disclosure, the driving based on the partition region and the partition frequency, and the refresh restart in any row, which will not be described in detail here.

In the first phase t1, the previous-stage shift register unit outputs a low-level signal, the first clock signal terminal CK outputs a low-level signal, and the second clock signal terminal CB outputs a high-level signal. At this time, the eleventh transistor M11 is turned on to transmit the low-level signal output by the previous-stage shift register unit to the fifth node N5, thereby setting the third node N3 to be a low-level through the eighteenth transistor M18. Under the control of the low-level signal at the third node N3, the fifteenth transistor M15 is turned on to transmit the high-level signal output from the second clock signal terminal CB to the output terminal ‘Output’ for output. At the same time, under the control of the low level output from the first clock signal terminal CK, the thirteenth transistor M13 is turned on, the fourth node N4 is set to a low level. Therefore, the fourteenth transistor M14 is turned on to output the second level signal VGH, and thus the shift register unit outputs a high-level signal at this time.

In the second phase t2, the first clock signal terminal CK outputs a high level and the second clock signal terminal CB outputs a low level. At this time, the eleventh transistor M11 and the thirteenth transistor M13 are turned off, the fifth node N5 maintains the low level in the previous phase, and the twelfth transistor M12 is turned on to transmit the high level on the first clock signal terminal CK to the fourth node N4, pulling the fourth node N4 to be high, thereby turning off the fourteenth transistor M14. At the same time, the third node N3 is maintained at a low level to control the fifteenth transistor M15 to be turned on. The fifteenth transistor M15 is turned on and transmits the low level on the second clock signal terminal CB to the output terminal ‘Output’, allowing the shift register unit to output a low level. At this point, the shift output of the shift register unit is achieved.

In the third phase t3, if the first clock signal terminal CK outputs a low level and the second clock signal terminal CB outputs a high level, the fourth node N4 will be set to a low level, and the fourteenth transistor M14 is turned on to output the second level signal VGH, allowing the shift register unit to output a high level. At the same time, the eleventh transistor M11 is turned on, setting the fifth node N5 to be a high level. At this time, the third node N3 is set to be a high level, so that the fifteenth transistor M15 is controlled to be turned off.

In the fourth phase t4, the first clock signal terminal CK outputs a high level and the second clock signal terminal CB outputs a low level. The fourth node N4 maintains the low level in the previous phase, and the fourteenth transistor M14 is turned on, allowing the shift register unit to output the second level signal VGH, i.e., a high level. At the same time, under the control of the low-level at the fourth node N4, the sixteenth transistor M16 is turned on. Under the control of the low-level signal output from the second clock signal terminal CB, the seventeenth transistor M17 is turned on, transmits the second level signal VGH to the fifth node N5, and resets the fifth node N5. The fifth node N5 and the third node N3 maintain a high level.

Afterwards, the first clock signal terminal CK and the second clock signal terminal CB alternately output a low level, and the shift register unit continues to output a high level until the input terminal ‘Input’ obtains a low level again, repeating the first phase t1 to the fourth phase t4.

It should be noted that the high level and the low level mentioned in the present disclosure refer to the two logical states represented by the potential ranges of circuit nodes. For example, the high level at the fourth node N4 can specifically refer to a level higher than the common terminal voltage, and the low level at the fourth node N4 can specifically refer to a level lower than the common terminal voltage. The specific potential range can be set as needed in specific application scenarios, and the present disclosure does not limit it.

As shown in FIG. 8, in some embodiments, when the display panel is displaying normally, the first clock signal terminal CK and the second clock signal terminal CB alternately output low-level signals, and the shift register unit shifts the low-level signal from the initial signal terminal and outputs the shift signal stage by stage.

As shown in FIG. 8, in some embodiments, there is a time interval (a, b in the figure) between the low-level signal output from the first clock signal terminal CK and the low-level signal output from the second clock signal terminal CB. In the same cycle, the duty cycle of the high-level signal output from the first clock signal terminal CK is greater than the duty cycle of the low-level signal output from the first clock signal terminal CK. Similarly, the duty cycle of the high-level signal output from the second clock signal terminal CB is greater than that of the low-level signal output from the second clock signal terminal CB. In this way, during the period when the first clock signal terminal CK outputs a low-level signal, the second clock signal terminal CB can be controlled to output always a high-level signal, and during the period when the second clock signal terminal CB outputs a low-level signal, the first clock signal terminal CK can be controlled to output always a high-level signal. As a result, the low-level signals output from the first clock signal terminal CK and the second clock signal terminal CB are controlled not to overlap with each other, ensuring the normal operation of the shift register unit and avoiding output errors.

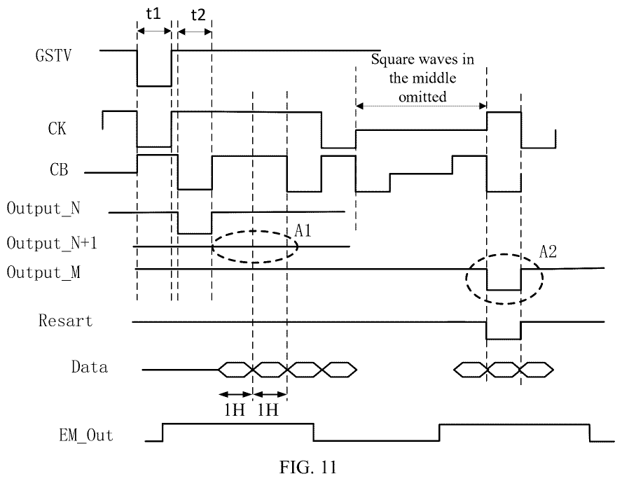

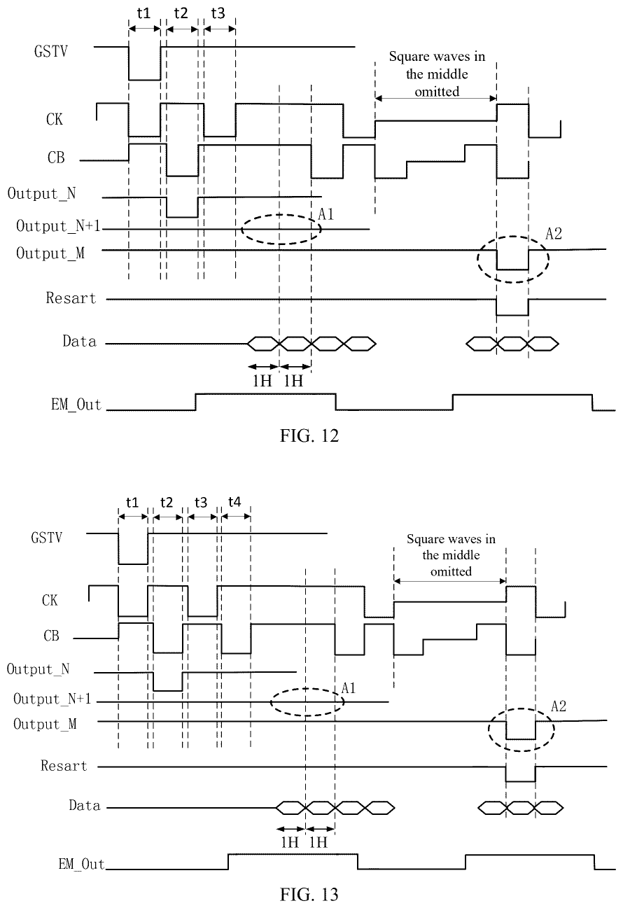

FIG. 9 is a schematic diagram of cascaded first gate driving circuit and second gate driving circuit composed of the shift register unit shown in FIG. 8. FIGS. 10 TO 13 are timing diagrams of the circuit shown in FIG. 9. It should be understood that the timing shown in FIGS. 10 to 13 is illustrated for the second shift register unit 200 described in the above embodiments, and the timing of the first shift register unit 100 can always be as shown in FIG. 8. As shown in FIG. 10, in some embodiments, when the display panel is driven based on the partition region and the partition frequency, as shown at A1 in FIGS. 10 TO 13, the first clock signal terminal CK and the second clock signal terminal CB can be controlled to output high-level signals, that is, both output non-turned-on levels. In this way, regardless of which output phase the shift register unit is in before, the shift register unit cannot output the output signal cascaded down from the previous stage, achieving interruption of the cascaded output. It should be noted that the duration for the first clock signal terminal CK and the second clock signal terminal CB to simultaneously output high-level signals is at least 2H, where 1H is a pulse width, which is the charging time of a single row, that is, a ratio of a frame time to all pixel rows in the display panel, where the frame time is the reciprocal of the refresh frequency.

In some embodiments, as shown in FIG. 10, if the shift register unit is now in the first phase t1, then after the first phase t1, both the first clock signal terminal CK and the second clock signal terminal CB output high-level signals for at least 2H. At this time, the eleventh transistor M11 and the thirteenth transistor M13 are turned off, the fifth node N5 maintains the low level in the previous phase, and the twelfth transistor M12 is turned on to transmit the high level from the first clock signal terminal CK to the fourth node N4, pulling the fourth node N4 high and turning off the fourteenth transistor M14. At the same time, the third node N3 maintains a low level, and the fifteenth transistor M15 is controlled to be turned on. The fifteenth transistor M15 is turned on and transmits the high level from the second clock signal terminal CB to the output terminal ‘Output’, causing the shift register unit to output a high level.

As shown in FIG. 11, if the shift register unit is now in the second phase t2, then after the second phase t2, both the first clock signal terminal CK and the second clock signal terminal CB output high-level signals for at least 2H. At this time, the fourth node N4 maintains a high level, the fourteenth transistor M14 is turned off, and the fifth node N5 maintains a low level. Therefore, the third node N3 controls the fifteenth transistor M15 to be turned on, so that the shift register unit outputs a high-level signal from the second clock signal terminal CB.

As shown in FIG. 12, if the shift register unit is in the third phase t3, then after the third phase t3, both the first clock signal terminal CK and the second clock signal terminal CB output high-level signals for at least 2H. At this time, the fifth node N5 maintains a high level, causing the third node N3 to be at high level and the fifteenth transistor M15 to be turned off. At the same time, the fourth node N4 maintains the low level in the previous phase, and the fourteenth transistor M14 is turned on to output the second level signal VGH, that is, the shift register unit outputs a high-level signal at this time.

As shown in FIG. 13, if the shift register unit is in the fourth phase t4, then after the fourth phase t4, both the first clock signal terminal CK and the second clock signal terminal CB output high-level signals for at least 2H. At this time, the fifth node N5 and the third node N3 maintain high levels, and the fifteenth transistor M15 is turned off. The fourth node N4 maintains a low level, and the fourteenth transistor M14 is turned on to output the second level signal VGH, that is, the shift register unit outputs a high-level signal.

It can be seen that regardless of which phase the shift register unit is in, by controlling the first clock signal terminal CK and the second clock signal terminal CB to output high-level signals for at least 2H, the shift register unit cannot obtain the low-level signal output by the previous-stage shift register unit, and the cascade output is interrupted, thereby interrupting the refresh of the display area.

Reference is continued to be made to FIGS. 10 TO 13, when a certain row needs to restart refreshing, as shown at A2 in the figure, the display driver integrated circuit DDIC can control the restart control terminal ‘Restart’ to output a low-level signal to turn on the control unit 400. At this time, the first shift register unit 100 corresponding to this row outputs a low-level signal, and the control unit 400 that has been turned on transmits the low-level signal output by the first shift register unit 100 in this row to the second shift register unit 200 in this row. It is equivalent that the second shift register unit 200 obtains the cascaded output signal of the previous stage and enters the first phase t1 shown in FIG. 8 to start the cascaded output, thereby causing the refreshing restart of the panel to be started from this row.

The present disclosure also provides a display panel driving method, for driving the display panel described in any of the above embodiments of the present disclosure. The driving method can be performed by a display driver integrated circuit DDIC, and the driving method can include the following steps.

In step S110, a starting row corresponding to a target region on which refreshing needs to be stopped is determined.

In step S120, a target clock signal terminal in a second shift register unit 200 corresponding to the starting row is controlled to output a non-turned-on level simultaneously, to control the second shift register unit 200 to continuously output the non-turned-on level.

In some embodiments, the target clock signal terminal includes the first clock signal terminal CK and the second clock signal terminal CB described in the above embodiments. The non-turned-on level can be, for example, the low level. This step is to control the first clock signal terminal CK and the second clock signal terminal CB in the second shift register unit 200 that provides the second gate driving signal for the starting row in the target region to output a high level, to control the cascade output of the second shift register unit 200 to be interrupted from that row.

In some embodiments, as shown in FIG. 10, the starting row from which the refresh is interrupted is in the (n+1)^{th} row, corresponding to A1 in the figure. The second shift register unit 200 outputs a low-level signal in the n^{th} row. At this time, the first clock signal terminal CK and the second clock signal terminal CB in the second shift register unit 200 are controlled to output high-level signals. In this way, the second shift register unit 200 in the (n+1)^{th} row will output a high-level signal, that is, the low-level signal output by the second shift register unit 200 in the nth row cannot be output in the second shift register unit 200 in the (n+1)^{th} row, and all subsequent rows cannot output cascaded signals. This can allow the output of the second gate driving circuit GOA2 is interrupted from the (n+1)^{th} row, that is, achieving the refresh interruption from the (n+1)^{th} row. In some embodiments, the duration of the non-turned-on level output simultaneously by the target clock signal terminal is greater than or equal to 2H.

In step S130, a target row on which refreshing needs to be restarted is determined, where the first shift register unit 100 corresponding to the target row outputs a first gate driving signal having a turned-on level.

In step S140, the restart control terminal ‘Restart’ is controlled to output a turned-on level signal to turn on each control unit 400. The second shift register unit 200 corresponding to the target row uses the first gate driving signal of the turned-on level for shift output.

In some embodiments, reference is made to FIG. 10, the target row is the m^{th} row, that is, the refresh is restarted from the m^{th} row. The display driver integrated circuit DDIC can control, based on the output signal of the first shift register unit 100, the timing of the restart control terminal ‘Resart’ outputting the turned-on level. In other words, when the restart control terminal ‘Resart’ outputs the turned-on level, the m^{th} row of the first shift register unit 100 outputs a low-level cascade signal. At this time, the control unit 400 that is turned on transmits the low-level signal output by the m^{th} row of the first shift register unit 100 to the output terminal ‘Output’ of the m^{th} row of the second shift register unit 200. As described above, after the input terminal ‘Input’ of the m^{th} row of the second shift register unit 200 obtains the low-level signal, the second shift register unit 200 will perform a shift output, that is, the cascaded output is started again from the m^{th} row, achieving restarting of the cascading transmission. In this way, the refresh is restarted in the m^{th} pixel row in the display area. In some embodiments, the duration of the turned-on level signal output by the restart control terminal ‘Resart’is 1H.

It should be noted that in some embodiments, the refreshing restart performed in any row can be achieved through the set control circuit Part_Crl.

The present disclosure also provides a display device. The display device can include the display panel as described in any of the above embodiments of the present disclosure.

After considering the specification and practicing of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

1. A display panel, comprising a first gate driving circuit, a second gate driving circuit, and a control circuit, wherein the first gate driving circuit comprises multiple cascaded first shift register units, the second gate driving circuit comprises multiple cascaded second shift register units, the control circuit comprises multiple control units, and the first shift register units, the second shift register units, and the control units are arranged in correspondence; and
wherein each control unit is connected to an output terminal of each first shift register unit, an input terminal of each second shift register unit, and a restart control terminal, and the control unit is configured to transmit, in response to a signal from the restart control terminal, an output signal of the first shift register unit to the input terminal of the second shift register unit.

2. The display panel according to claim 1, wherein each of the control units share the same restart control terminal.

3. The display panel according to claim 1, wherein the control unit comprises:
a first control transistor, wherein a first electrode of the first control transistor is connected to the output terminal of the first shift register unit, a second electrode of the first control transistor is connected to the input terminal of the second shift register unit, a gate of the first control transistor is connected to the restart control terminal, and the first control transistor is configured to transmit, in response to the signal from the restart control terminal, the output signal of the first shift register unit to the input terminal of the second shift register unit.

4. The display panel according to claim 3, wherein the control unit further comprises:
a second control transistor, wherein a first electrode and a gate of the second control transistor are connected to the output terminal of the first shift register unit, a second electrode of the second control transistor is connected to the first electrode of the first control transistor, and the second control transistor is configured to transmit, in response to the output signal of the first shift register unit, the output signal to the first electrode of the first control transistor.

5. The display panel according to claim 4, wherein a duration during which the restart control terminal outputs a turned-on level is 1H, where H is a pulse width, and represents charging time of a single row.

6. The display panel according to claim 1, wherein the display panel further comprises a pixel driving circuit located in a display area, and the pixel driving circuit comprises:
a driving transistor, wherein a first electrode of the driving transistor is connected to a second node, a second electrode of the driving transistor is connected to a third node, a gate of the driving transistor is connected to s first node, and the driving transistor is configured to provide a driving current by using a voltage difference between the second node and the third node under control of a voltage at the first node;
a first transistor, wherein a first electrode of the first transistor is connected to the first node, a second electrode of the first transistor is connected to a first initial signal terminal, a gate of the first transistor is connected to a first reset signal terminal, and the first transistor is configured to reset, in response to a signal from the first reset signal terminal, the first node using a voltage signal from the first initial signal terminal; and
a second transistor, wherein a first electrode of the second transistor is connected to the first node, a second electrode of the second transistor is connected to the third node, a gate of the second transistor is connected to an output terminal of the second shift register unit corresponding thereto, and the second transistor is configured to charge, in response to a gate driving signal output by the second shift register unit, the first node using a voltage signal at the third node;
wherein the first reset signal terminal reuses an output signal of the second shift register unit.

7. The display panel according to claim 1, wherein the first shift register unit and the second shift register unit have the same circuit structures.

8. The display panel according to claim 7, wherein the first shift register unit and the second shift register unit each comprises:
an input module connected to an output terminal of a corresponding shift register unit in a previous stage, a fifth node, and a first clock signal terminal, wherein the input module is configured to transmit, in response to a signal from the first clock signal terminal, a received output signal of the previous-stage shift register unit to the fifth node;
a pull-down module connected to a fourth node and the first clock signal terminal, wherein the pull-down module receives a first level signal, and is configured to pull, in response to the signal from the first clock signal terminal, down the fourth node using the first level signal;
a pull-up module connected the fourth node, the fifth node, and the first clock signal terminal, wherein the pull-up module is configured to pull, in response to a signal at the fifth node, up the fourth node using the signal from the first clock signal terminal;
a reset module connected to the fourth node, the fifth node, and a second clock signal terminal, wherein the reset module receives a second level signal, and is configured to reset, in response to a signal at the fourth node and a signal from the second clock signal terminal, the fifth node using the second level signal;
a protection module connected to the fifth node and the third node, wherein the protection module receives the first level signal, and is configured to transmit, in response to the first level signal, the signal at the fifth node to the third node, and to be turned off in response to a voltage difference between the first level signal and the signal at the third node;
a first output module connected to the fourth node and the output terminal, wherein the first output module receives the second level signal, and is configured to transmit, in response to the signal at the fourth node, the second level signal to the output terminal;
a second output module connected to the third node, the output terminal, and the second clock signal terminal, wherein the second output module is configured to transmit, in response to the signal at the third node, the signal from the second clock signal terminal to the output terminal;
a second storage module connected to the third node and the output terminal, wherein the second storage module is configured to perform bootstrap on a potential of the third node when a polarity of the signal from the second clock signal terminal is the same as a polarity of the signal at the third node; and
a first storage module connected to the fourth node, wherein the first storage module receives the second level signal, and is configured to maintain voltage stability of the fourth node.

9. The display panel according to claim 1, wherein the second shift register unit comprises an input module and an output module, the input module is connected to a first clock signal terminal, and the output module is connected to a second clock signal terminal;
when the display panel is driven for display at a same refresh frequency, the first clock signal terminal and the second clock signal terminal alternately output a turned-on level; and
when the display panel is driven by different refresh frequencies based on partition regions, both the first clock signal terminal and the second clock signal terminal output a non-turned-on level, and a duration of the non-turned-on level is greater than or equal to 2H, where His a pulse width, and represents charging time of a single row.

10. The display panel according to claim 8, wherein when the display panel is driven for display at a same refresh frequency, a turned-on level output from the first clock signal terminal does not overlap with a turned-on level output from the second clock signal terminal.

11. The display panel according to claim 8, wherein
the input module comprises:
an eleventh transistor, wherein a first terminal of the eleventh transistor is connected to the output terminal of the corresponding shift register unit in the previous stage, a second terminal of the eleventh transistor is connected to the fifth node, a control terminal of the eleventh transistor is connected to the first clock signal terminal, and the eleventh transistor is configured to transmit, in response to the signal from the first clock signal terminal, the received output signal of the previous-stage shift register unit to the fifth node;
the pull-down module comprises:
a thirteenth transistor, wherein a first terminal of the thirteenth transistor receives the first level signal, a second terminal of the thirteenth transistor is connected to the fourth node, a control terminal of the thirteenth transistor is connected to the first clock signal terminal, and the thirteenth transistor is configured to pull, in response to the signal from the first clock signal terminal, down the fourth node using the first level signal;
the pull-up module comprises:
a twelfth transistor, wherein a first terminal of the twelfth transistor is connected to the fourth node, a second terminal of the twelfth transistor is connected to the first clock signal terminal, a control terminal of the twelfth transistor is connected to the fifth node, and the twelfth transistor is configured to pull, in response to the signal at the fifth node, up the fourth node using the signal from the first clock signal terminal;
the reset module comprises:
a sixteenth transistor, wherein a first terminal of the sixteenth transistor receives the second level signal, a second terminal of the sixteenth transistor is connected to the second node, a control terminal of the sixteenth transistor is connected to the fourth node, and the sixteenth transistor is configured to transmit, in response to the signal at the fourth node, the second level signal to the second node; and
a seventeenth transistor, wherein a first terminal of the seventeenth transistor is connected to the second node, a second terminal of the seventeenth transistor is connected to the fifth node, a control terminal of the seventeenth transistor is connected to the second clock signal terminal, and the seventeenth transistor is configured to reset, in response to the signal from the second clock signal terminal, the fifth node using the signal at the second node;
the protection module comprises:
an eighteen transistor, wherein a first terminal of the eighteen transistor is connected to the fifth node, a second terminal of the eighteen transistor is connected to the third node, a control terminal of the eighteen transistor receives the first level signal, and the eighteen transistor is configured to transmit, in response to the first level signal, the signal at the fifth node to the third node, and to be turned off in response to the voltage difference between the first level signal and the signal at the third node;
the first output module comprises:
a fourteenth transistor, wherein a first terminal of the fourteenth transistor receives the second level signal, a second terminal of the fourteenth transistor is connected to the output terminal, a control terminal of the fourteenth transistor is connected to the fifth node, and the fourteenth transistor is configured to transmit, in response to the signal at the fourth node, the second level signal to the output terminal;
the second output module comprises:
a fifteenth transistor, wherein a first terminal of the fifteenth transistor is connected to the second clock signal terminal, a second terminal of the fifteenth transistor is connected to the output terminal, a control terminal of the fifteenth transistor is connected to the third node, and the fifteenth transistor is configured to transmit, in response to the signal at the third node, the signal from the second clock signal terminal to the output terminal for output;
the second storage module comprises:
a second capacitor, wherein one end of the second capacitor is connected to the third node and the other end of the second capacitor is connected to the output terminal, and the second capacitor is configured to perform the bootstrap on the signal at the third node when the polarity of the signal from the second clock signal is the same as the polarity of the signal at the third node; and
the first storage module comprises:
a first capacitor, wherein one end of the first capacitor is connected to the fourth node and the other end of the first capacitor receives the second level signal, and the first capacitor is configured to maintain a potential of the fourth node.

12. The display panel according to claim 11, wherein the eleventh transistor to the eighteen transistor are all P-type transistors.

13. A display panel driving method, for driving the display panel according to claim 1, the method comprising:
determining a starting row corresponding to a target region on which refreshing needs to be stopped;
controlling a target clock signal terminal in a second shift register unit corresponding to the starting row to simultaneously output a non-turned-on level, to control the second shift register unit to continuously output the non-turned-on level;
determining a target row on which the refreshing needs to be restarted, wherein a first shift register unit corresponding to the target row outputs a signal having a turned-on level; and
controlling a restart control terminal to output a signal having the turned-on level to turn on each control unit, wherein the second shift register unit corresponding to the target row uses the signal having the turned-on level output by the first shift register unit for shift output.

14. The method according to claim 13, wherein a duration during which the target clock signal terminal simultaneously output the non-turned-on level is greater than or equal to 2H, where H is a pulse width, and represents charging time of a single row.

15. The method according to claim 13, wherein a duration during which the restart control terminal outputs the signal having the turned-on level is 1H, where H is a pulse width, and represents charging time of a single row.

16. A display device comprising a display panel, wherein the display panel comprises a first gate driving circuit, a second gate driving circuit, and a control circuit, wherein the first gate driving circuit comprises multiple cascaded first shift register units, the second gate driving circuit comprises multiple cascaded second shift register units, the control circuit comprises multiple control units, and the first shift register units, the second shift register units, and the control units are arranged in correspondence; and
wherein each control unit is connected to an output terminal of each first shift register unit, an input terminal of each second shift register unit, and a restart control terminal, and the control unit is configured to transmit, in response to a signal from the restart control terminal, an output signal of the first shift register unit to the input terminal of the second shift register unit.

17. The display device according to claim 16, wherein each of the control units share the same restart control terminal.

18. The display device according to claim 16, wherein the control unit comprises:
a first control transistor, wherein a first electrode of the first control transistor is connected to the output terminal of the first shift register unit, a second electrode of the first control transistor is connected to the input terminal of the second shift register unit, a gate of the first control transistor is connected to the restart control terminal, and the first control transistor is configured to transmit, in response to the signal from the restart control terminal, the output signal of the first shift register unit to the input terminal of the second shift register unit.

19. The display device according to claim 18, wherein the control unit further comprises:
a second control transistor, wherein a first electrode and a gate of the second control transistor are connected to the output terminal of the first shift register unit, a second electrode of the second control transistor is connected to the first electrode of the first control transistor, and the second control transistor is configured to transmit, in response to the output signal of the first shift register unit, the output signal to the first electrode of the first control transistor.

20. The display device according to claim 19, wherein a duration during which the restart control terminal outputs a turned-on level is 1H, where H is a pulse width, and represents charging time of a single row.
